(19) United States
(12) Patent Application Publication
(10) Pub. No.: US 2016/0134992 A1
(43) Pub. Date: May 12, 2016

(54) METHOD AND APPARATUS FOR DELIVERING DIGITAL CONTENT OVER MOBILE NETWORK

(71) Applicant: Angelica Figueiredo White, (US)

(72) Inventor: Angelica Figueiredo White, Johns Creek, GA (US)

(73) Assignee: Angelica Figueiredo White, Johns Creek, GA (US)

(21) Appl. No.: 14/537,888

(22) Filed: Nov. 10, 2014

(51) Int. Cl. H04W 4/00; H04W 4/16

(52) U.S. Cl. CPC H04W 4/003; H04W 4/16

(57) ABSTRACT

A method and apparatus for delivering digital content via mobile devices and mobile networks, is disclosed. In an embodiment, a product provider is provided with artefact identification, such as QRcode, which holds a unique key for digital content storage and retrieval. A mobile user of the application, as a sender, scans the artefact unique identification and is connected to a cloud system where a personalized digital message can be recorded using a variety of digital content. A mobile user of the application as recipient scans artefact unique identification and retrieves the digital message. The mobile app is responsible for handling the proper display of content. Mobile app provides recipient with options for storing, managing and viewing content from personal library. A Digital Content Management System is responsible for the artefact unique identification administration and customer account personal libraries administration.

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### FIELD OF THE INVENTION

This invention relates to customized digital content delivery over mobile device and mobile network.

### BACKGROUND OF THE INVENTION

The custom of sending greeting cards can be traced back to the ancient Chinese, who exchanged messages of good will to celebrate the New Year, and to the early Egyptians, who conveyed their greetings on papyrus scrolls. In the U.S. 7 billion greeting cards are purchased every year. Annual retail sales of greeting cards are estimated at more than $7.5 billion. The 2.65 billion Christmas cards sold each year in the U.S. could fill a football field 10 stories high. During Thanksgiving to New Year's Americans dispose of an extra 25 million tons of garbage. The environmental concerns around paper waste, and the high demand for digital content delivery and as well online shopping, create an opportunity to address the following issues:
Reduce waste
Attaching personal digital greetings to gifts purchased from stores
Attaching personal greetings to gifts bought online
Archiving and organizing digital or printed greetings
The sharing and display of digital and printed greetings

### BRIEF SUMMARY OF THE INVENTION

A method and apparatus for delivering digital content via mobile devices and mobile networks, is disclosed. In an embodiment, a product provider is provided with artefact identification, such as QRcode, known as SLCode, which holds a unique key for digital content storage and retrieval. A mobile user of the application, as a sender, scans the artefact unique identification and is connected to a cloud system where a personalized digital message can be recorded using a variety of digital content. A mobile user of the application as recipient scans artefact unique identification and retrieves the digital message. The mobile app is responsible for handling the proper display of content. Mobile app provides recipient with options for storing, managing and viewing content from personal library. A Digital Content Management System is responsible for the artefact unique identification administration and customer account personal libraries administration.

### BRIEF DESCRIPTION OF THE SEVERAL VIEWS OF THE DRAWING

Features and advantages of the present invention will become apparent from the following description of pictures thereof, by way of example only, to the accompanying drawings, in which:

FIG. 1 shows the schematic diagram illustrating elements engaged in a code based digital content creation and delivery over a mobile device and mobile network.

FIG. 2 shows an apparatus carrying a SLCode in accordance with an embodiment of the present invention in which SLCode can be concealed

FIG. 3 shows a workflow diagram of a sender process creating digital content using SLCode as presented in this invention

FIG. 4 shows a workflow diagram of a recipient process receiving digital content using SLCode as presented in this invention

FIG. 5 shows a workflow diagram of a recipient process managing personal library digital content as presented in this invention

FIG. 6 shows a workflow diagram illustrating the transaction process for SLCode administration

FIG. 7 shows a potential illustration of a SLCode representing unique system generated identification for digital content storage and delivery, perhaps concealed or such as QRCode.

### DETAILED DESCRIPTION OF THE INVENTION

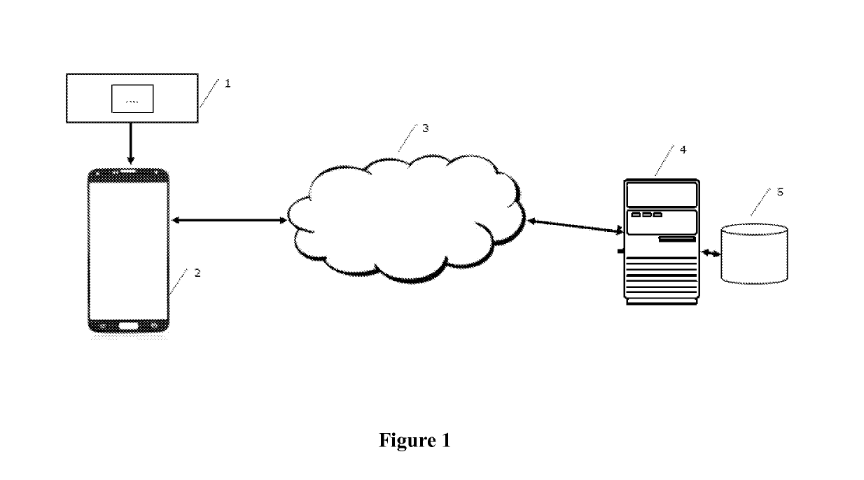

FIG. 1 shows the schematic diagram illustrating elements engaged in a code based digital content creation and delivery over a mobile device and mobile network.

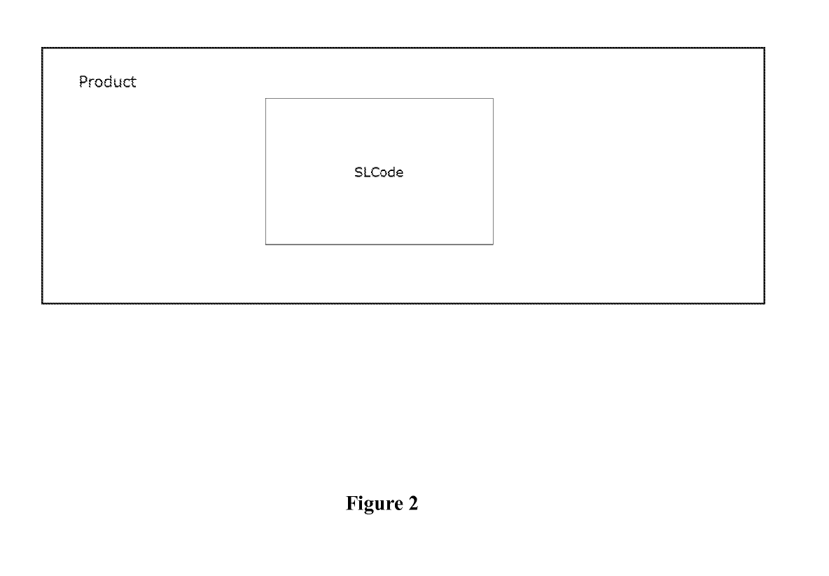

FIG. 2 shows an apparatus carrying a SLCode in accordance with an embodiment of the present invention, in which SLCode can be concealed

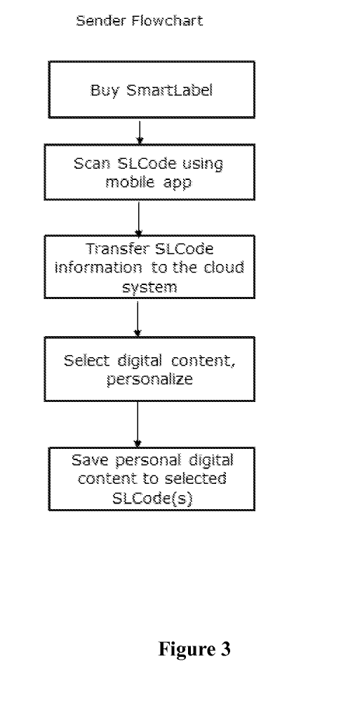

FIG. 3 shows a workflow diagram of a sender process creating digital content using SLCode as presented in this invention

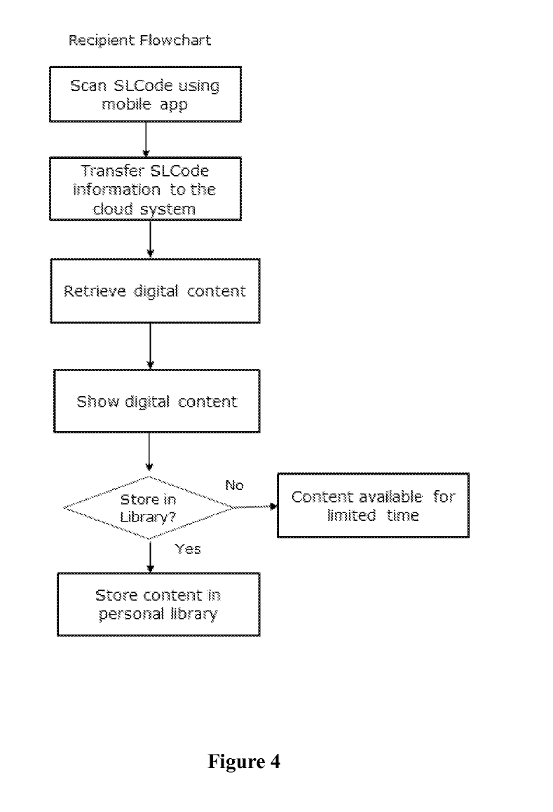

FIG. 4 shows a workflow diagram of a recipient process receiving digital content using SLCode as presented in this invention

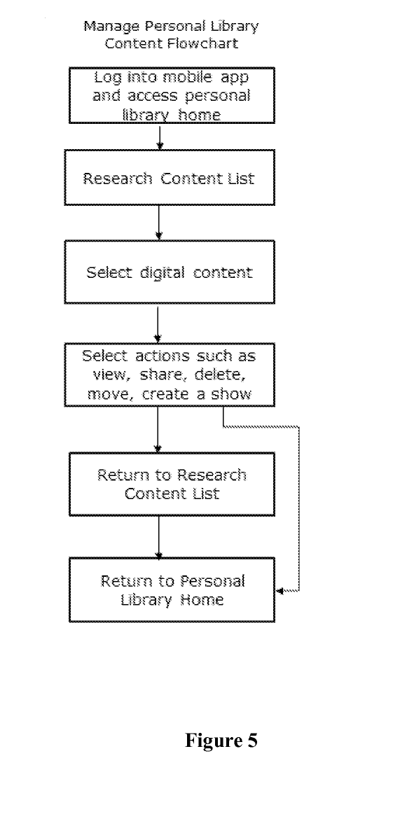

FIG. 5 shows a workflow diagram of a recipient process managing personal library digital content as presented in this invention

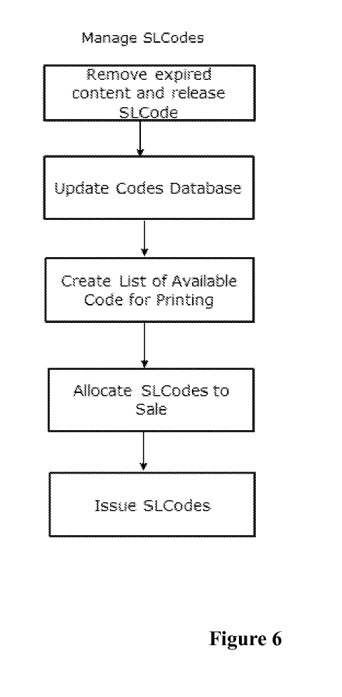

FIG. 6 shows a workflow diagram illustrating the transaction process for SLCode administration

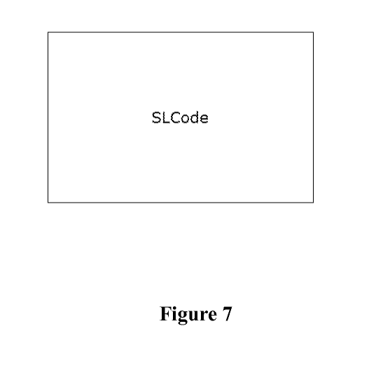

FIG. 7 shows a potential illustration of a SLCode representing unique system generated identification for digital content storage and delivery, perhaps concealed or such as QRCode

1. A customer apparatus for facilitating digital content creation and delivery, comprising of a mobile application to read a product provider artefact storing an unique identification code, to create or obtain a digital content data; and a transaction data processor arranged to connect over a communication network to a cloud digital content management system to the administration of unique identification artefacts and mobile application transaction processing of such artefacts; and for administering a customer account of the customer and associated personal libraries.

2. An apparatus in accordance with claim 1, the customer apparatus comprising a mobile device

3. An apparatus in accordance with claim 1, wherein the product provider artifact is a visible or concealed code.

4. An apparatus in accordance with claim 1, wherein the product provider artifact comprises a memory for storing a unique identification for creating or retrieving digital content.

5. An apparatus in accordance with claim 1, wherein the mobile application reads product provider artefact and enables the creation of digital content associated to this artefact unique identification.

6. An apparatus in accordance with claim 1, wherein mobile application allows product provider artefact digital content to be stored in personal library of customer account

7. An apparatus in accordance with claim 1, wherein mobile application allows the creation of customer account and personal library of customer account for mobile digital content created with unique identification artefact

8. An apparatus in accordance with claim 1, wherein mobile application allows the administration of digital content store in personal library of customer account

9. An apparatus in accordance with claim 1, wherein the cloud digital content management system is responsible for processing mobile application transactions over a communication network; and administration and generation of artefact unique identification codes.
